(19) United States
(12) Patent Application Publication
(10) Pub. No.: US 2006/0081452 A1
(43) Pub. Date: Apr. 20, 2006

(54) Push-on switch

(76) Inventors: Yasunori Yanai, Okayama (JP); Hisashi Watanabe, Okayama (JP)

Correspondence Address: WENDEROTH, LIND & PONACK L.L.P., 2033 K. STREET, NW, SUITE 800, WASHINGTON, DC, 20006, US

(21) Appl. No.: 11/250,547

(22) Filed: Oct. 17, 2005

(30) Foreign Application Priority Data
Oct. 20, 2004 (JP) 2004-305476

(51) Int. Cl. H01H 5/18

(52) U.S. Cl. 200/406

(57) ABSTRACT

A push-on switch according to the present invention is structured so that a pressing part in which its elastic body bends without comfortableness to move up and down faces the top surface of a dome-shaped movable contact, with a given clearance. Such a makeup allows a distance until the pressing part touches the movable contact to be utilized for pre-loading, even if the movable contact with a short operation stroke is used.

### BACKGROUND OF THE INVENTION

1. Field of the Invention

The present invention relates to a push-on switch that is used as an operating switch for an input operation unit in an electric apparatus including an electric component such as a car air-conditioner, and audiovisual equipment.

2. Background Art

In recent years, a push-on switch is widely used as an operating switch for an input operation unit in an electric apparatus including a car air-conditioner and audiovisual equipment.

A description will be made for such a conventional push-on switch, using FIG. 7.

FIG. 7 is a sectional view of the conventional push-on switch. In FIG. 7, case 1 is a case made of insulating resin, open at its top. Fixed contact 2 (2A and 2B), made of a pair of metal plates, is insert-molded to be fixed to the central part of inner bottom surface 1A of case 1.

The bottom end of movable contact 3, made of an elastic thin metal plate, formed in a dome shape, and open at its bottom, is placed on fixed contact 2B disposed at the outer position. In this case, the bottom surface of movable contact 3 maintains a clearance of the height of the dome from fixed contact 2A at the central position that corresponds to the position below the central top of movable contact 3.

Power driver 4, made of rigid material, is placed movably up and down on the central top of above-mentioned movable contact 3. This power driver 4 is composed of flange 4A, circularly formed at the position of an intermediate height; lower pressing part 4B, with a small diameter, projectingly formed on the bottom surface of flange A; and operating projection 4C, projectingly formed on the top surface of lower pressing part 4B. The bottom surface of above-mentioned lower pressing part 4B touches the central top of above-mentioned movable contact 3.

Meanwhile, operating projection 4C of power driver 4 projects upward through a through-hole disposed on cover 5. The cover 5 is combined with case 1 so as to cover the opening of case 1, where the top surface of flange 4A of power driver 4 touches the bottom surface of cover 5 in a non-operational state.

The conventional push-on switch with the structure as mentioned above is mounted to a cabinet or the like so that a pressing operation can be performed with set knob 7, which is an operation button in the electric apparatus, disposed movably up and down, as shown in FIG. 7.

When operating projection 4C of power driver 4 is pressed through above-mentioned set knob 7, the central top of movable contact 3 is immediately pressed by lower pressing part 4B provided on the bottom of power driver 4, and then a given force causes movable contact 3 to invert at its central part with comfortableness. Consequently, the bottom surface of movable contact 3 touches fixed contact 2A centrally disposed; and then fixed contact 2B externally located, short-circuits with fixed contact 2A centrally located, through movable contact 3, to enter a switch-on state.

Movable contact 3, when pressing power driver 4 is stopped, returns to its original dome shape upward convex, with comfortableness, owing to its own restorative force, to separate from fixed contact 2A centrally positioned. Then, power driver 4 is pressed back upward according to the restorative action, to enter the original switch-off state shown in FIG. 7.

Here, information on prior art documents related to the present invention includes Japanese Patent Unexamined Publication No. 2002-343178.

However, in the above-mentioned conventional push-on switch, small dimensional tolerance is required for the parts of the electric apparatus in order to incorporate set knob 7 for pressing down power driver 4, without rattle.

### SUMMARY OF THE INVENTION

An object of the present invention is, in order to solve such a conventional problem, to provide a push-on switch that allows combination with a set knob with a given pre-load applied and suppresses rattle and the like of the set knob.

In order to achieve the above-mentioned object, a push-on switch according to the present invention includes a case made of insulating resin, provided with a plurality of fixed contacts, electrically independent, on the bottom surface of the recess of the case with its top open; a movable contact, made of a metal plate, formed in a dome shape, that inverts with comfortableness to contact and break the fixed contacts one another; an elastic body contained in the recess of the case, equipped with a pressing part positioned above the movable contact with a given distance, the pressing part bending due to a pressing operation without comfortableness, to move up and down; and a cover mounted on the case so as to cover the top surface of the recess of the case.

Such a makeup allows this elastic body to be combined with the set knob with a given pre-load applied to the elastic body, using a dome-shaped movable contact with a short operation stroke, in an initial press-down distance, which refers to a distance from when the elastic body starts bending without comfortableness until the pressing part contacts the top surface of the movable contact, thus suppressing rattle and the like of the set knob. Meanwhile, a wide range of the dimensional tolerance when designing the parts of the electric apparatus helps improve the designing flexibility.

### BRIEF DESCRIPTION OF THE DRAWINGS

FIG. 1 is a sectional view of a push-on switch according to an embodiment of the present invention.

FIG. 2 is a partially sectional, perspective view of a power driver, which is a substantial part of the push-on switch.

FIG. 3 is a figure showing a feeling curve of the push-on switch.

FIG. 4 is a sectional view of the push-on switch in operation.

FIG. 5 is a sectional view of the push-on switch in operation.

FIG. 6 is a sectional view of the push-on switch incorporated into an electric apparatus.

FIG. 7 is a sectional view of the conventional push-on switch.

### DETAILED DESCRIPTION OF THE INVENTION

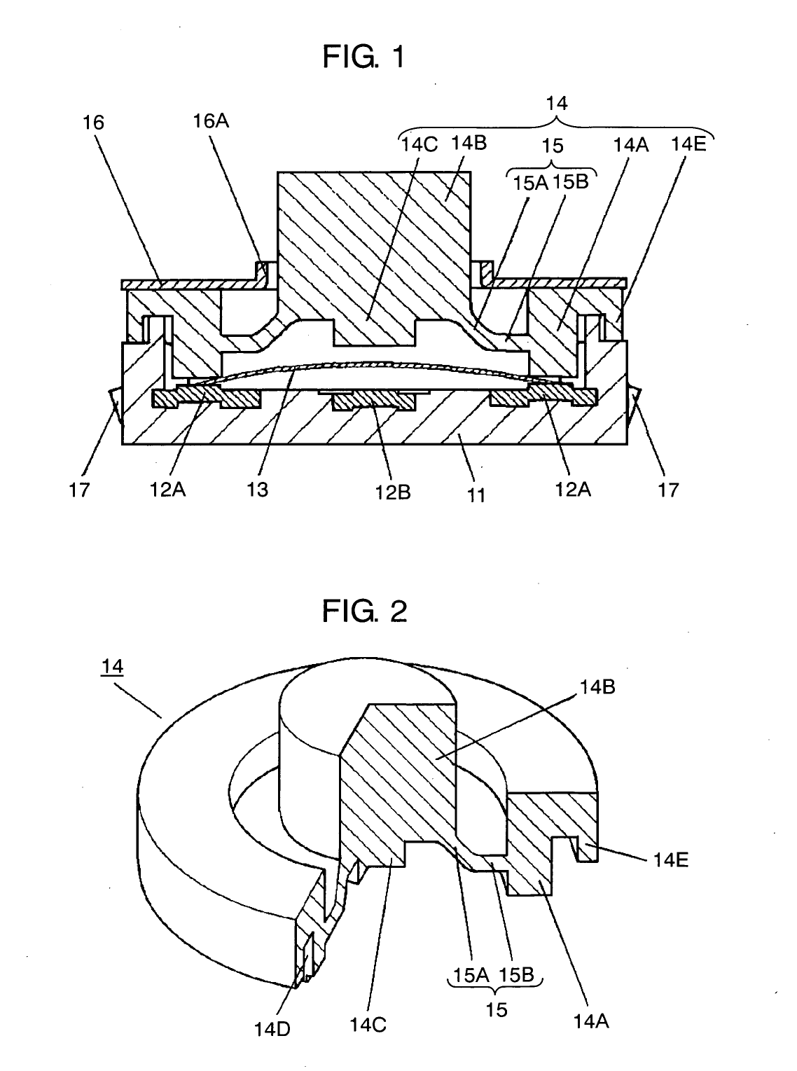

Hereinafter, a description will be made for an embodiment of the present invention, using FIGS. 1 through 6.

### Embodiment

FIG. 1 is a sectional view of a push-on switch according to an embodiment of the present invention.

In FIG. 1, case 11 is a case made of insulating resin having a recess open at its top. The inner bottom surface of the recess is formed as a contact-arranged part further concave with its round central part. Outer fixed contact 12A and central fixed contact 12B are disposed in an electrically independent state each other at the bottom outer circumference of the contact-arranged part and its central position, respectively.

Movable contact 13 is made of a highly-conductive thin metal plate and is formed in a dome shape upward convex. The bottom end of the dome-shaped outer circumference is placed on outer fixed contact 12A in the contact-arranged part. The bottom surface of the central top of movable contact 13 faces above-mentioned central fixed contact 12B with a given clearance. Movement of movable contact 13 to the side is restricted by the step composing a round recess, which is to be a contact-arranged part, where detailed illustration is omitted. Elastic body 14 made of an elastomer is disposed above movable contact 13.

FIG. 2 is a partially sectional, perspective view of a power driver, which is a substantial part of the push-on switch according to the embodiment of the present invention. As shown in FIG. 2, elastic body 14 is equipped with periphery 14A, tubular with a diameter roughly identical to that of movable contact 13. Cylindrical part 14B with its top composing an operating part is connected to periphery 14A through thin-walled part 15, movably up and down, in the central hole of the periphery 14A. Still, the bottom end of above-mentioned periphery 14A is placed on the periphery of movable contact 13. The bottom end surface of the cylindrical part 14B is equipped with pressing part 14C, with a small diameter, projecting downward. Here, the respective parts of elastic body 14 is integrally formed.

Above-mentioned thin-walled part 15 is composed of conical part 15A with its bottom open, extendedly formed from the bottom of the outer circumference of cylindrical part 14B; and horizontal part 15B linking to the bottom end of the conical part 15A. Pressing part 14C of the bottom end of cylindrical part 14B supported by this thin-walled part 15 is retained at a position to face the top surface of the central top of movable contact 13, with a given clearance. Here, the angle and wall thickness of conical part 15A are set so as not to cause comfortableness in an invert action. Horizontal part 15B is formed parallel to the bottom surface of case 11, in a ring shape concentrically with the central axis of cylindrical part 14B as the center, from the top view.

As shown in FIG. 2, several grooves 14D crossing periphery 14A are provided on the bottom end of periphery 14A. This structure allows internal and external air in the space above movable contact 13 to circulate. Here, through-holes or the like, instead of grooves 14D, may be provided on periphery 14A so that internal and external air in the space above movable contact 13 circulates.

Retainer 14E, hook-shaped from the section view, is integrally formed on the outer circumference of periphery 14A of elastic body 14, and is hooked on the top end of the outer circumferential wall composing the recess of case 11. Here, the outer circumferential portion of retainer 14E is composed so as to stay within case 11 in the above-mentioned hooking state.

Cover 16 is a cover made of a metal plate, combined with above-mentioned case 11 so as to cover the opening of case 11. Its central part is equipped with tubular part 16A with the periphery of its central round hole upward burring-processed. Cylindrical part 14B of above-mentioned elastic body 14 projects upward through the central round hole of tubular part 16A.

Such a makeup allows cylindrical part 14B supported only by thin-walled part 15 in a non-operational state, to move up and down along the inner circumferential surface of tubular part 16A, thus reducing prying operations and the like. Here, instead of forming tubular part 16A with a metal plate, a tubular molded part may be integrally insert-molded at the end of the central hole of the metal plate, for example.

Cover 16 is assembled so as to slightly press down the top end surface of periphery 14A of elastic body 14 in a state of being combined with case 11, and thus periphery 14A is in a state of being slightly compressed. Movable contact 13 press-contacts outer fixed contact 12A owing to a force caused by the compression of periphery 14A, maintaining an electrically stable contact condition. Here, terminals 17 extend out of case 11 from outer fixed contact 12A and central fixed contact 12B, both disposed in above-mentioned case 11, respectively.

A push-on switch according to the present invention is composed as mentioned above.

Next, a description will be made for the actions of a push-on switch according to the present invention and its feeling curve.

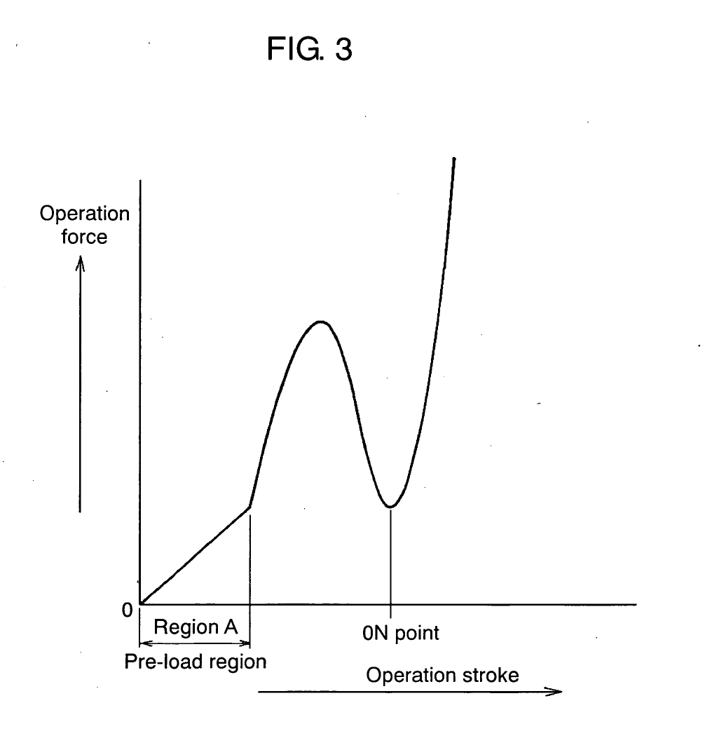

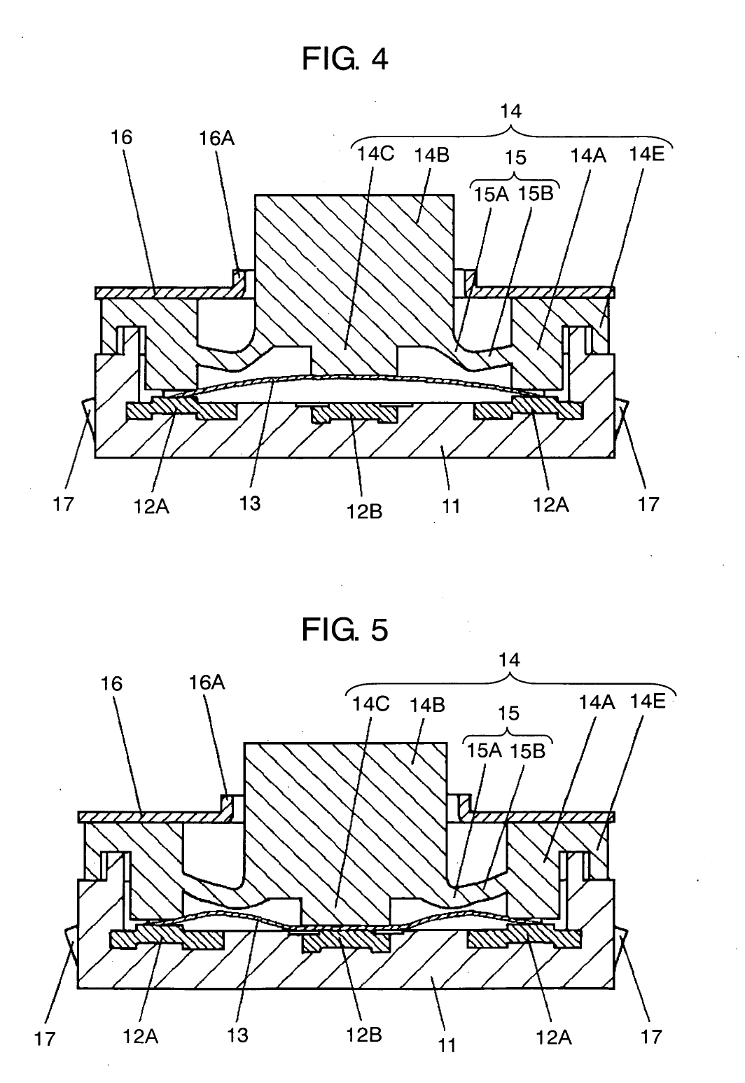

FIG. 3 is a figure showing a feeling curve of the push-on switch according to the embodiment of the present invention. FIG. 4 is a sectional view of the push-on switch in operation, according to the embodiment of the present invention.

As a result that the top end of cylindrical part 14B, projecting from cover 16, of elastic body 14 is pressed, the rising angle from horizontal part 15B of conical part 15A of elastic body 14 becomes slightly low, and at the same time, the central part of horizontal part 15B, ring-shaped, continues to bend downward. Then as shown in FIG. 4, the distance between the bottom end surface of pressing part 14C and the top surface of movable contact 13 decreases to enter a state in which both of them touch each other.

In this case, such a shape of thin-walled part 15 allows elastic body 14 to be formed simply and easily. In the above-mentioned actions in particular, the central portion of horizontal part 15B, which becomes the side of the connection with conical part 15A, moves down, and thin-walled part 15 of elastic body 14 can be made so that it continues to elastically bend.

The outer circumferential surface of cylindrical part 14B moves down along tubular part 16A of cover 16, and thus pressing part 14C touches movable contact 13 in accordance with the position of the central top of movable contact 13, with few prying actions or the like.

The above-mentioned actions press to contract the space above movable contact 13, the space enclosed with the top surface of movable contact 13, tubular periphery 14A of elastic body 14, and the bottom surface of thin-walled part 15 connected to periphery 14A, to compress the air in the space as well. However, the makeup that allows air to circulate through grooves 14D disposed on the bottom end of periphery 14A hardly influences an operation force or the like due to the air compression, thus stabilizing the above-mentioned actions.

In the actions so far, thin-walled part 15 in a so-called cantilevered state merely continues to bend without comfortableness when cylindrical part 14B moves. Therefore, the operation force is roughly proportional to the operation stroke in region A (pre-load region) in FIG. 3.

Here, the strength of the operation force can be set as appropriate by setting the shape of thin-walled part 15 or other methods. For example, a shape of conical part 15A with a high rising angle from horizontal part 15B allows the operation force to require a strong one. Further, horizontal part 15B may be gradient with its central portion and outer circumference vertically out of alignment, or both the above-mentioned structures may be combined.

Here, in region A shown in FIG. 3, that is to say, in the initial press-down distance, which refers to a distance until pressing part 14C of elastic body 14 contacts the top surface of movable contact 13, comfortableness does not occur. In a case where elastic body 14 deviates with a weak force of approximately 0.3 N to 1 N, for example, and additionally the operation stroke, which is a moving distance of the elastic body 14, is set to approximately 0.5 mm to 0.6 mm, region A can be utilized as a pre-load region.

FIG. 5 is a sectional view of the push-on switch in operation, according to the embodiment of the present invention. As shown in FIG. 5, when a pressing force is further applied to cylindrical part 14B, with pressing part 14C of elastic body 14 touching movable contact 13, pressing part 14C presses down and inverts movable contact 13. At this moment, movable contact 13 inverts with comfortableness. The central bottom surface of movable contact 13 contacts central fixed contact 12B disposed on the contact-arranged part of case 11, with an operation stroke at the ON point shown in FIG. 3. Then, central fixed contact 12B short-circuits with outer fixed contact 12A through movable contact 13, to enter a switch-on state.

Thin-walled part 15 deviates downward roughly linearly at the central portions of conical part 15A and horizontal part 15B. The force required to the deviation is added to an invert action force of movable contact 13. If the maximum value of an invert action force of movable contact 13 is set to a value roughly more than twice the maximum deformation force in region A, which is a pre-load region, a finger or the like for operation reliably feels comfortableness.

Here, even during the above-mentioned actions, cylindrical part 14B moves down with its tilt being restricted by tubular part 16A of cover 16, thus causing few prying operations or the like, and additionally the air in the space above movable contact 13 flows out through grooves 14D of periphery 14A, resulting in stable actions.

When a pressing force to cylindrical part 14B of elastic body 14 is released, movable contact 13 restores to its original state with comfortableness due to its own restorative force, and its bottom surface separates from central fixed contact 12B, entering the original switch-off state. Further, thin-walled part 15 of elastic body 14, having been bent, returns to the original shapes of horizontal part 15B and conical part 15A, due to the own restorative force. That is, as shown in FIG. 1, pressing part 14C returns to a state of separating above from movable contact 13 with a given clearance.

At this moment, the application force of thin-walled part 15 elastically bending is weak as a restorative force in the above-mentioned restorative action. However, as a result that external air flows into the closed space above movable contact 13 through grooves 14D provided on tubular periphery 14A shown in FIG. 2, the restorative action is aided, resulting in a smooth and stable return action.

As mentioned above, a push-on switch according to an embodiment of the present invention is structured so that pressing part 14C of elastic body 14 faces movable contact 13 with a given distance, and an initial press-down distance, which refers to a distance until pressing part 14C contacts the top surface of movable contact 13 without comfortableness, can be secured. Therefore, the initial press-down distance can be utilized as a pre-load region.

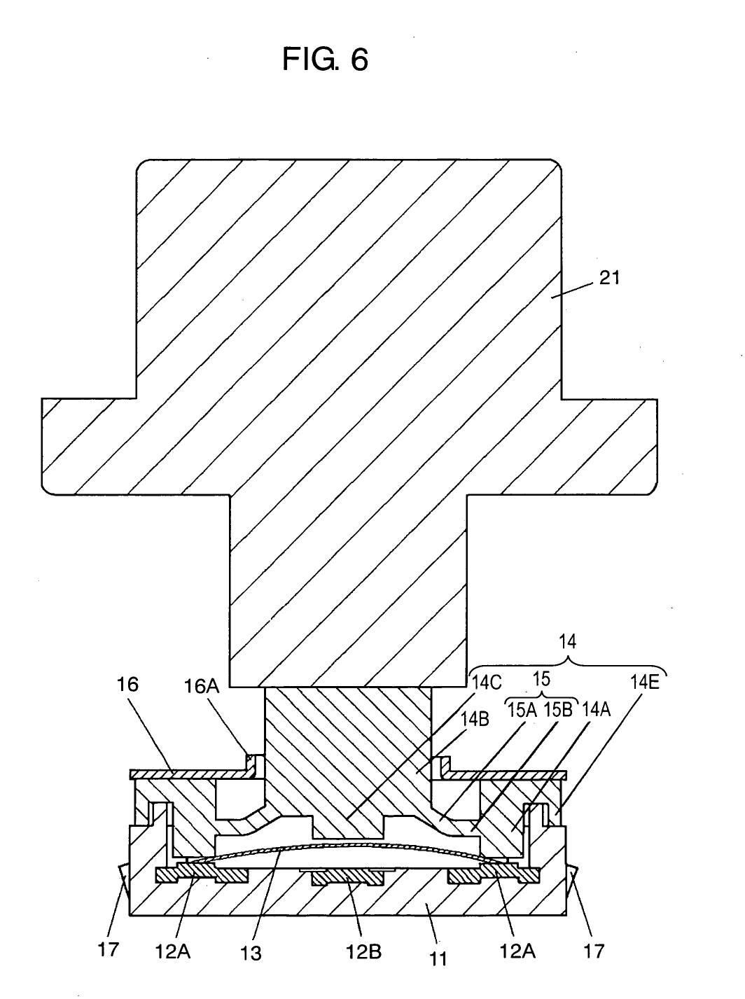

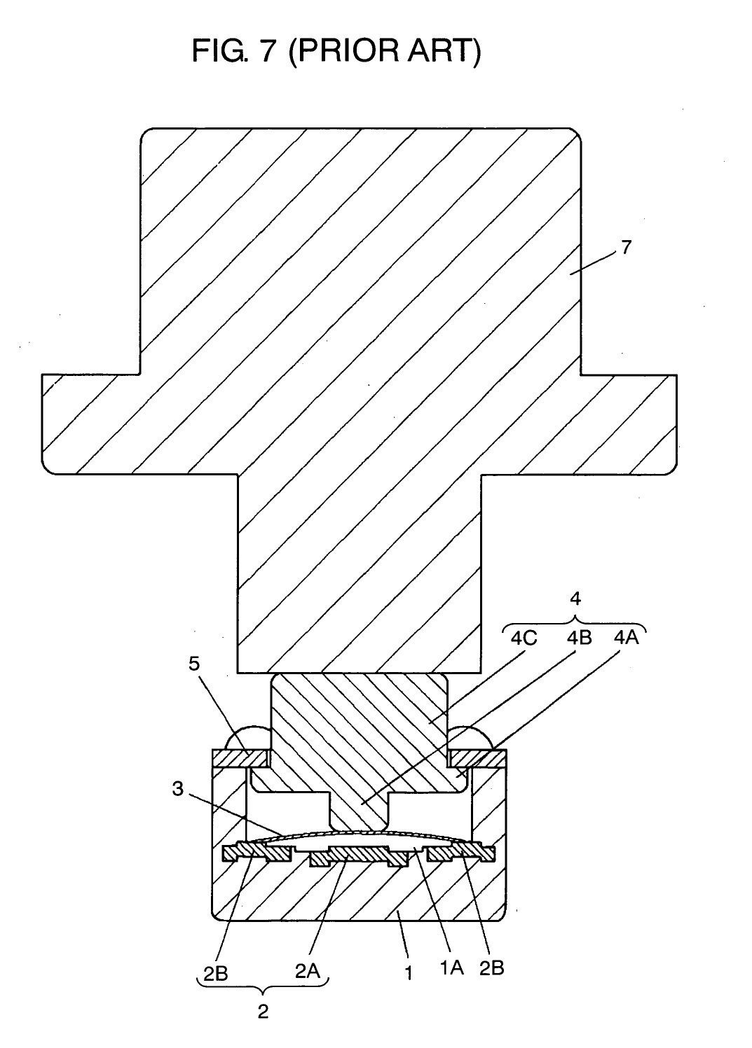

FIG. 6 is a sectional view of the push-on switch incorporated into an electric apparatus, according to the embodiment of the present invention. As shown in FIG. 6, when incorporating the push-on switch into an electric apparatus, set knob 21, which is an operation button in the electric apparatus, disposed movably up and down, is positioned with thin-walled part 15 of elastic body 14 slightly bent in region A, or a pre-load region, before disposing the push-on switch. This makeup allows maintaining a state of movable contact 13 not in operation, as well as a state of incorporating the push-on switch while rattle of set knob 21 is suppressed owing to a reactive force from above-mentioned thin-walled part 15. In this case, considering fit dimensions of set knob 21 into the cabinet, finish dimensions of set knob 21, and the like, set knob 21 preferably performs an initial press-down of cylindrical part 14B, aiming at the intermediate position of the operation stroke in region A.

In this way, in a push-on switch according to the present invention, even if composed of movable contact 13, dome-shaped with its short operation stroke, the push-on switch can be incorporated into an electric apparatus with set knob 21 combined, with a given pre-load applied to elastic body 14. Further, rattle and the like of set knob 21 can be suppressed while the range of the dimensional tolerance and the like when designing the parts of the electric apparatus are expanded to improve the designing flexibility.

What is claimed is:

1. A push-on switch, comprising:
a case made of insulating resin, including a plurality of fixed contacts electrically independent, on a bottom surface of a recess with a top thereof open;
a movable contact made of a metal plate, formed in a dome-like shape, that inverts with comfortableness to contact and to break the fixed contacts one another;
an elastic body disposed in a recess of the case and positioned above the movable contact with given distance, that bends without comfortableness to move up and down; and
a cover mounted to the case so as to cover a top surface of the recess of the case.

2. The push-on switch as claimed in claim 1, wherein the elastic body includes:
a pressing part projectingly formed on a bottom end of a cylindrical part;
a conical part extendedly formed with a thin wall from an outer circumference of the cylindrical part; and
a horizontal part horizontally extended from a bottom end of the conical part.

3. The push-on switch as claimed in claim 1, wherein a bottom end of a periphery of the elastic body is arranged on a periphery of the movable contact, and further includes a member having one of a groove and a through-hole for circulating internal and external air, at the periphery of the elastic body that corresponds to a space above the movable contact, enclosed with the elastic body and the movable contact.
